(19) United States
(12) Patent Application Publication
(10) Pub. No.: US 2025/0018821 A1
(43) Pub. Date: Jan. 16, 2025

(54) VIRTUAL POWER PLANTS FOR ELECTRIC GRID SUPPORT UTILIZING SMART CHARGING

(71) Applicant: ABB E-mobility B.V., Delft (NL)

(72) Inventors: Zhenyuan Wang, Apex, NC (US); Alexander McGrath Brissette, Raleigh, NC (US); Yuzhi Zhang, Apex, NC (US); David Lee Coats, Bellevue, WA (US); Himani Ravindra Pathak, Bensalem, PA (US)

(21) Appl. No.: 18/351,175

(22) Filed: Jul. 12, 2023

(51) Int. Cl. B60L 53/66; B60L 53/64; B60L 53/68; G06Q 50/06

(52) U.S. Cl. CPC B60L 53/665; B60L 53/64; B60L 53/68; G06Q 50/06; B60L 2240/72

(57) ABSTRACT

In one aspect, a method of managing a participation of a virtual power plant (VPP) comprising a plurality of electric vehicle supply equipment (EVSE) in an ancillary service market for an electric grid is provided. The method comprises generating a bid for participating in the ancillary service marked over a time period, transmitting the bid to the ancillary service market, receiving a response from the ancillary service market indicating that the bid was accepted, and identifying a request from the ancillary service market for the VPP to provide grid support to the electric grid during the time period. The method further comprises generating, based on the bid and in response to the request, at least one charging profile for one or more of the EVSEs, and providing the at least one charging profile to the one or more of the EVSEs to implement the request for grid support.

### STATEMENT REGARDING FEDERALLY SPONSORED RESEARCH AND DEVELOPMENT

This invention was made with U.S. government support under contract number DE-EE0009194 awarded by the U.S. Department of Energy. The U.S. government has certain rights in this invention.

### BACKGROUND

The field of the disclosure relates to electric grid support activities, and in particular, to electric vehicle supply equipment (EVSE) that provide grid support.

In an electric grid, automatic generation control (AGC) is used for adjusting the power output of multiple electric generators at different power plants in response to changes in the load on the electric grid. Because the electric grid relies on a balance between electric generation and load, real-time adjustments in the output of the electric generators is used to maintain a stable frequency of the electric grid. As the load on the electric grid is increasing above the amount of electricity being generated, the frequency of the electric grid decreases, which is offset using AGC at the power plants to increase the amount of electric power being supplied to the electric grid to meet the experienced demand. When the load on the electric grid is decreasing below the amount of electricity being generated, the frequency of the electric grid increases, which is offset using AGC at the power plants to decrease the amount of electrical power being supplied to the electric grid.

While AGC utilization has historically been implemented by the power plants supplying power to the electric grid, power plants are more profitable as a result of an increase in revenue generated when they increase their electric power generation and support the electric grid during frequency regulation events. In contrast, EVSEs increase generated revenue when they increase their electric load on the electric grid while charging electric vehicles (EVs), and therefore, there is no clear incentive for EVSEs to participate in grid support events that require the EVSEs to reduce their loads on the electric grid during grid support events, such as AGC events.

Thus, it would be desirable to provide incentives for EVSEs to participate in grid support events to improve the stability and reliability of the electric grid.

### BRIEF DESCRIPTION

In one aspect, a controller for managing a participation of a virtual power plant comprising a plurality of electric vehicle supply equipment in an ancillary service market for an electric grid is provided. The controller comprises at least one communication interface and at least one processor. The at least one processor is configured to generate a bid for participating in the ancillary service marked over a time period, transmit, via the at least one communication interface, the bid to the ancillary service market, receive, via the at least one communication interface, a response from the ancillary service market indicating that the bid was accepted, and identify a request from the ancillary service market for the virtual power plant to provide grid support to the electric grid during the time period. The controller is further configured to generate, based on the bid and in response to the request, at least one charging profile for one or more of the plurality of electric vehicle supply equipment of the virtual power plant, and provide, via the at least one communication interface, the at least one charging profile to the one or more of the plurality of electric vehicle supply equipment to implement the request for grid support.

In another aspect, a method of managing a participation of a virtual power plant comprising a plurality of electric vehicle supply equipment in an ancillary service market for an electric grid is provided. The method comprises generating a bid for participating in the ancillary service marked over a time period, transmitting the bid to the ancillary service market, receiving a response from the ancillary service market indicating that the bid was accepted, and identifying a request from the ancillary service market for the virtual power plant to provide grid support to the electric grid during the time period. The method further comprises generating, based on the bid and in response to the request, at least one charging profile for one or more of the plurality of electric vehicle supply equipment of the virtual power plant, and providing the at least one charging profile to the one or more of the plurality of electric vehicle supply equipment to implement the request for grid support.

In another aspect, a controller for managing a plurality of electric vehicle supply equipment for participation in a frequency control of an electric grid is provided. The controller comprises at least one processor configured to generate a bid to participate in the frequency control of the electric grid, determine whether the bid was accepted, and identify a request to provide the frequency control of the electric grid. The at least one processor is further configured to cause, based on the bid and in response to the request, one or more of the plurality of electric vehicle supply equipment to modify their electrical power drawn from the electric grid to implement the frequency control of the electric grid.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings.

FIG. 1 depicts a block diagram of a controller for managing a participation of a virtual power plant in an ancillary service market in an exemplary embodiment.

FIG. 2 depicts a block diagram of another controller for managing a participation of another virtual power plant in the ancillary service market in an exemplary embodiment.

FIG. 3 depicts functional components of elements of FIG. 2 in an exemplary embodiment.

FIG. 4 depicts a flow chart of a method of calculating a base revenue during a grid support event in an exemplary embodiment.

FIG. 5 depicts a flow chart of a method of managing a participation of a virtual power plant comprising a plurality of electric vehicle supply equipment in an ancillary service market for an electric grid in an exemplary embodiment.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general-purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

EVSEs often impart a significant electrical load on the electric grid, which can negatively impact ongoing AGC events or other types of grid support events being implemented by grid operators. For example, EVSEs may be increasing their load on the electric grid while grid operators are directing power plants via AGC signals or other types of grid support events to increase their electric generation, which is contrary to what the grid operators would prefer during such events.

The federal energy regulatory commission (FERC) has issued orders (including FERC “755”) to independent system operators (ISOs) and regional transmission operators (RTOs) to implement performance-based compensation for frequency regulation services, which enables fast acting (e.g., inverter-based) resources such as wind, solar, and EVSEs to respond to AGC signals from the grid operator in order to capture more revenue than they would under the traditional capacity-based compensation schemes. However, unlike wind and solar plants, whose purpose is to provide energy supplies and can have a minimal running cost (e.g., fuel cost), the main purpose of EVSEs is to supply energy to EVs, and the business value for EVSEs to participate in the frequency regulation service market or other types of grid support events is unclear. Therefore, in order to improve the reliability of the electric grid and to promote the participation of EVSEs in the frequency regulation service market and other types of grid support events, various incentives are needed to promote the participation of EVSEs and provide for the profitable operation of the EVSEs during grid support events.

In the present disclosure, various embodiments are disclosed that enable EVSEs to be aggregated as a virtual power plant (VPP) for participation in the wholesale ancillary service market, and in particular, for participation in the secondary frequency regulation market, based on AGC principles. For example, a plurality of EVSEs of an electric vehicle site solution (EVSS) may temporarily participate in AGC events to implement frequency regulation of the electric grid, with the owner of the EVSS provided compensation for participation to at least offset and/or supersede the lost revenue from decreasing the EV charging rate at the EVSEs. These and other features will be described in more detail below.

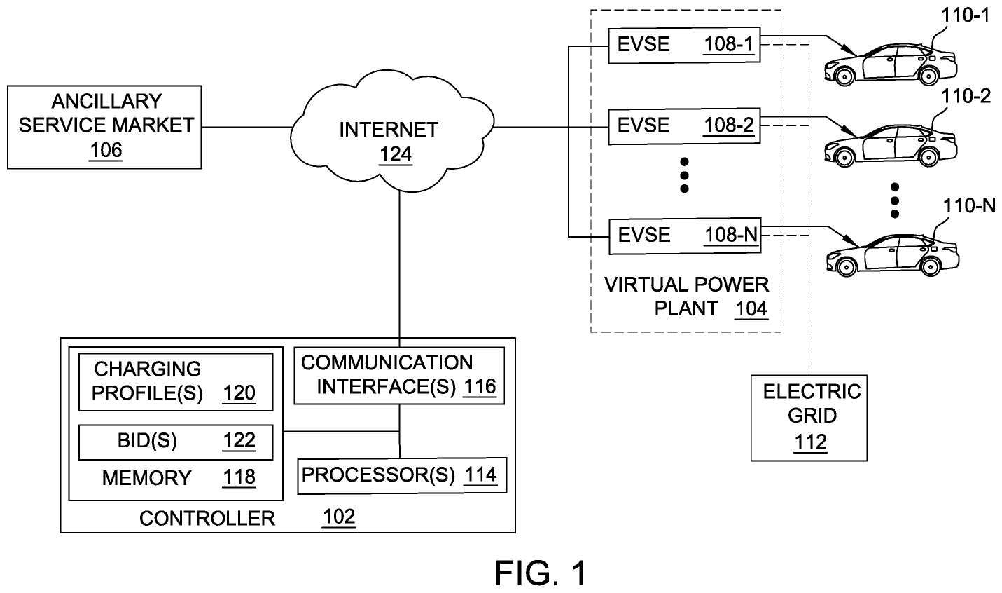

FIG. 1 depicts a block diagram of a controller 102 for managing a participation of a virtual power plant (VPP) resource group 104 in an ancillary service market 106 in an exemplary embodiment. In this embodiment, VPP resource group 104 comprises a plurality of EVSEs 108, which are used to charge EVs 110. EVSEs 108 are electrically coupled to an electric grid 112, and EVSEs 108 are an electrical load on electric grid 112 while charging EVs 110.

In the embodiments described herein, controller 102 comprises any component, system, or device that performs the functionality described herein for controller 102. Controller 102 will be described with respect to various discrete elements, which perform functions. These elements may be combined in different embodiments or segmented into different discrete elements in other embodiments. In this embodiment, controller 102 comprises at least one processor 114, at least one communication interface 116, and at least one memory 118. Memory 118 stores one or more charging profiles 120 and at least one bid 122. Charging profiles 120 define how EVSEs 108 charge their corresponding EVs 110, and bid 122 is generated by controller 102 and provided to ancillary service market 106 in order to participate in grid support of electric grid 112. In some embodiments, charging profiles 120 define how EVs 110 provide electric power to their corresponding EVSEs 108, which is used to back feed energy into electric grid 112. This type of activity is referred to as vehicle-to-grid, or VTG. With VTG technologies, the EV batteries of EVs 110 can be discharged based on charging profiles 120 to supply electricity to electric grid 112. In some embodiments, controller 102 and/or ancillary service market 106 are implemented at least partially in cloud computing environment.

In this embodiment, VPP resource group 104 comprises EVSE 108-1, which charges EV 110-1, EVSE 108-2, which charges EV 110-2, and EVSE 108-N, which charges EV 110-N. Although FIG. 1 depicts VPP resource group 104 as including three EVSEs 108, VPP resource group 104 may have a different number of EVSEs 108 in other embodiments.

In this embodiment, controller 102 is communicatively coupled to ancillary service market 106 via communication interfaces 116 and the Internet 124. Communication interfaces 116 may comprise any wired interface, wireless interface, or combinations thereof, which facilitates the communication of controller 102 with EVSEs 108 and ancillary service market 106. Some examples of communication interface 116 includes WiFi interfaces, Ethernet interfaces, cellular network interfaces, etc.

During operation, controller 102 may generate a fuel cost curve for the immediate future (e.g., the next hour) and may determine bid 122 based on the fuel cost curve and a bidding strategy. Bid 122 may, for example, comprise a power level and a price for VPP resource group 104 to participate in ancillary service market 106.

Controller 102 may transmit the bid to ancillary service market 106, via communication interface 116 and the Internet 124, and determine if bid 122 is accepted. If bid 122 is accepted, and a request is identified by controller 102 to participate in grid support (e.g., a request generated by and/or from ancillary service market 106 to provide grid support to electric grid 112), then controller 102 may enter into a grid support mode. During grid support mode, controller 102 may generate and/or modify charging profiles 120 (e.g., power limits for EVSEs 108) at time intervals (e.g., every two to four seconds), and may then provide charging profiles 120 to EVSEs 108 to decrease or increase the electric demand of VPP resource group 104 on electric grid 112. A decrease in the electric demand of VPP resource group 104 on electric grid 112 results in a net power supply injection into electric grid 112 (e.g., which may be used to increase the frequency of electric grid 112), while an increase in the electric demand of VPP resource group 104 on electric grid 112 results in a net power supply decrease in electric grid 112 (e.g., which may be used to reduce the frequency of electric grid 112).

The grid support mode may comprise, in various embodiments, AGC support of electric grid 112, spinning reserve support of electric grid 112, supplemental reserve support of electric grid 112, and/or other types of grid support of electric grid 112. AGC support, as previously describe above, is used to control the frequency of electric grid 112 by balancing the electrical power supplied to electric grid 112 with the electrical load on electric grid 112. During AGC support, controller 102 varies charging profiles 120 sent to EVSEs 108 to vary the electrical load that VPP resource group 104 imposes on electric grid 112.

Spinning reserve and supplemental reserve are used to provide energy to meet the demand on electric grid 112 in the event of a sudden and unexpected loss of a power generation or a transmission resource for electric grid 112. Prior to spinning reserve or supplemental reserve support, controller 102 may hold back or reserve a specified percentage of a potential EV charging capability in order to meet an emergency need. For example, controller 102 may hold back or reserve a pre-determined amount of potential EV charging power in order to meet the emergency need (e.g., charging profiles 120 supplied to EVSEs 108 may implement EV charging that is below the maximum possible charging rate). During spinning reserve or supplemental reserve support, controller 102 modifies charging profiles 120 sent to EVSEs 108 (e.g., via communication interfaces 116 and the Internet 124) to decrease the electrical load that VPP resource group 104 imposes on electric grid 112 by the pre-determined amount of potential charging power, thereby providing a net power injection into electric grid 112.

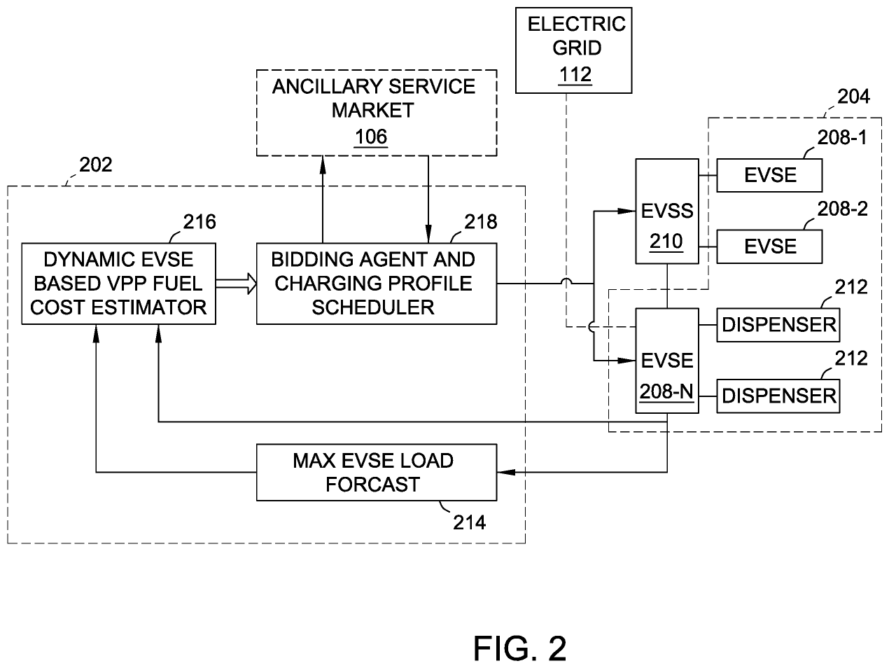

FIG. 2 depicts a block diagram of another controller 202 for managing a participation of a VPP resource group 204 in ancillary service market 106 in an exemplary embodiment. In this embodiment, VPP resource group 204 comprises a plurality of EVSEs 208. In particular, VPP resource group 204 in this embodiment comprises EVSE 208-1, EVSE 208-2, and EVSE 208-N, although VPP resource group 204 may include a different number of EVSEs 208 in other embodiments. In this embodiment, EVSEs 208-1. 208-2 are managed by an electric vehicle site solution (EVSS) 210, and EVSE 208-N is depicted as having two charging dispensers (e.g., charging cords) 212. In some embodiments, EVSS 210 may be referred to as a charging station control system. EVSS 210 manages EVSEs 208-1, 208-2 and may include controller 202 in some embodiments.

In some embodiments, controller 202 is at least partially implemented in EVSS 210, while in other embodiments, controller 202 and/or ancillary service market 106 may be at least partially implemented in a cloud-based computing environment. In the embodiments described herein, controller 202 comprises any component, system, or device that performs the functionality described herein for controller 202. Controller 202 will be described with respect to various discrete elements, which perform functions. These elements may be combined in different embodiments or segmented into different discrete elements in other embodiments. In some embodiments, controller 202 may include similar elements as controller 102 of FIG. 1. For example, controller 202 may include processors, memory, and communication interfaces similar to processors 114, memory 118, and communication interfaces 116 of controller 102 of FIG. 1, and may implement the functions described herein for controller 202 as firmware, hardware, and combinations thereof using such processors, memory, and communication interfaces.

In this embodiment, controller 202 includes a max EVSE load forecast module (MLF) 214, a dynamic EVSE based VPP fuel cost estimator module (FCE) 216, and a bidding agent/charging profile scheduler module 218 (BA/CPS). During operation, FCE 216 may generate a fuel cost curve for the immediate future (e.g., the next hour) and may send the fuel cost curve to BA/CPS 218. BA/CPS 218 may then determine a bid based on the fuel cost curve and a bidding strategy. The bid may, for example, comprise a power level and a price for participating in ancillary service market 106.

BA/CPS 218 may transmit the bid to ancillary service market 106, and determine if the bid is accepted. If the bid is accepted, and a request is identified by BA/CPS 218 to participate in grid support (e.g., a request generated by and/or from ancillary service market 106 to provide grid support), then controller 202 may enter into a grid support mode. During grid support mode, BA/CPS 218 may generate and/or modify charging profiles (e.g., power limits for EVSS 210 and/or EVSEs 208) at time intervals (e.g., every two to four seconds), and may then send the charging profiles to EVSS 210 and/or EVSEs 208 to decrease or increase the electric demand of VPP resource group 204 on electric grid 112. A decrease in the electric demand of VPP resource group 204 on electric grid 112 results in a net power supply injection into electric grid 112 (e.g., which may be used to increase the frequency of electric grid 112), while an increase in the electric demand of VPP resource group 204 on electric grid 112 results in a net power supply decrease in electric grid 112 (e.g., which may be used to reduce the frequency of electric grid 112).

The grid support mode may comprise, in various embodiments similar to that previously described, AGC support of electric grid 112, spinning reserve support of electric grid 112, supplemental reserve support of electric grid 112, and/or other types of grid support. AGC support, as previously describe above, is used to control the frequency of electric grid 112 by balancing the electrical power supplied to electric grid 112 with the electrical load on electric grid 112. During AGC support, BA/CPS 218 varies the charging profiles sent to EVSEs 208 and/or EVSS 210 to vary the electrical load that VPP resource group 204 imposes on electric grid 112.

Spinning reserve and supplemental reserve, as previously described above, are used to provide energy to meet the demand on electric grid 112 in the event of a sudden and unexpected loss of a power generation or a transmission resource for electric grid 112. Prior to spinning reserve or supplemental reserve support, controller 202 may hold back or reserve a specified percentage of a potential EV charging capability in order to meet an emergency need. For example, controller 202 may hold back or reserve a pre-determined amount of potential EV charging power in order to meet the emergency need (e.g., the charging profiles supplied to EVSEs 208 may implement EV charging that is below the maximum possible charging rate). During spinning reserve or supplemental reserve support, BA/CPS 218 modifies the charging profiles sent to EVSEs 208 and/or EVSS 210 to decrease the electrical load that VPP resource group 204 imposes on electric grid 112 by the pre-determined amount of potential charging power, thereby providing a net power injection into electric grid 112.

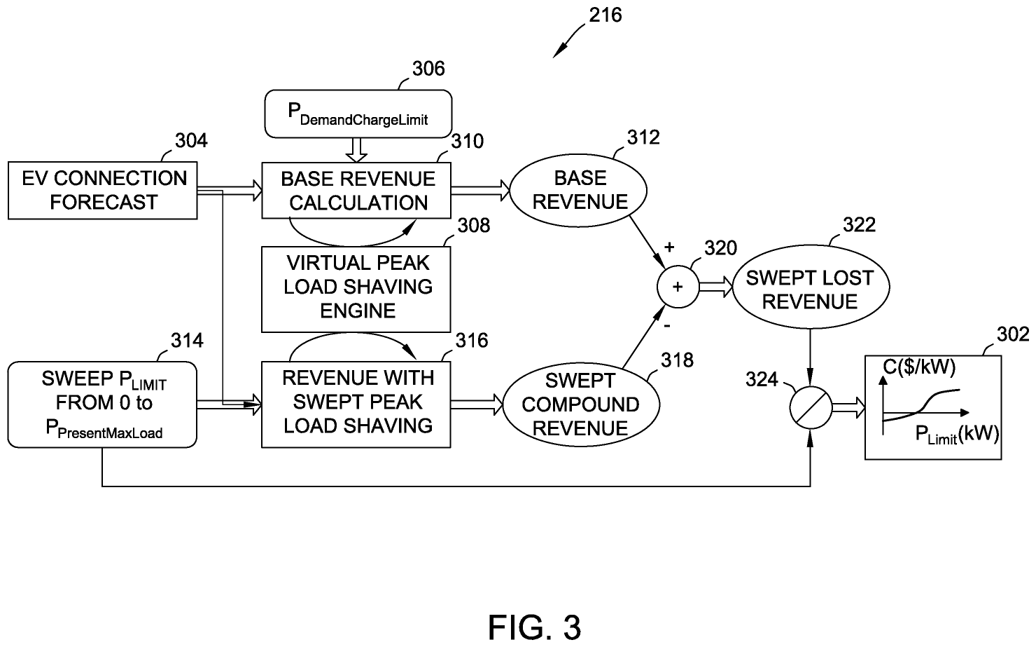

During operation, MLF 214 may generate an estimation (P_{PresentMaxLoad}) of the maximum demand of EVSEs 208 for the immediate future (e.g., the next hour), and MLF 214 may provide this information to FCE 216 in order for FCE 216 to generate the fuel cost curve used by BA/CPS 218 when generating bids for ancillary service market 106. MLF 214 may collect the information used to generate the estimate from EVSEs 208 and/or from EVSS 210 directly, and/or may utilize data analytics (e.g., a machine learning model) to collect the information. While the specific implementation of FCE 216 may vary depending on a number of different design factors, market factors, etc., one specific implementation of FCE 216 is described with respect to FIG. 3.

FIG. 3 depicts functional components of FCE 216 in an exemplary embodiment. Generally, FCE 216 operates in this embodiment to compare an estimated compound revenue from providing EV charging services with the opportunity cost of not providing the grid support. In this embodiment, a fuel cost curve 302 is generated based on a number of inputs and calculations. In particular, an EV connection forecast is performed in block 304, a P_{DemandChargeLimit} input is represented in block 306, where P_{DemandChargerLimit} corresponds to the power level either submitted as a bid or expected to be submitted as a bid for ancillary service market 106, or simply a locally determined limit to avoid incurring utility imposed peak demand charges. A virtual peak load shaving engine calculation is performed in block 308, each of which are inputs to a base revenue calculation, performed in block 310. The output of block 310 is a base revenue (Bᵣ), at block 312. A sweep calculation P_{Limit-i} is performed in block 314, which is described in more detail below, and block 314 is an input to a revenue with swept peak load shaving calculation, performed in block 316. Also input to block 316 is the output from the virtual peak load shaving engine calculation performed in block 308. The output of block 316 is a swept compound revenue (Cᵣ₋ᵢ), at block 318. Bᵣ and Cᵣ₋ᵢ are summed at block 320, and the result is a swept lost revenue (Lᵣ₋ᵢ), at block 322. Dividing Lᵣ₋ᵢ by P_{Limit-i} in block 324 generates the resulting fuel cost curve 302. The specifics of these inputs and calculations are described in more detail below.

The estimated compound revenue may be a series of values, calculated by sweeping though the range between zero and P_{PresentMaxLoad} at a fixed power interval (e.g., 10 kilowatts) with a variable P_{Limit-i}, and calculating a sum of EVSE 208 charging revenue and the revenue from participating in ancillary service market 106, for each P_{Limit-i}, to calculate a compound revenue Cᵣ₋ᵢ, where i=1, 2, 3 . . . . N, and N is a number of sweep times. The revenue opportunity cost from charging EVSEs 208, base revenue Bᵣ, may be a summation of the charging revenue from EVSEs 208 during the time frame (e.g., the next hour). In some embodiments, the calculation may include business model considerations at each EVSS 210 and/or EVSE 208. By subtracting Cri from Bᵣ, an array of lost revenue Lᵣ₋ᵢ is generated, which may be positive or negative. When Lᵣ₋ᵢ is negative, it may be beneficial to participate in ancillary service market 106. Flipping the signs of Lᵣ₋ᵢ and dividing Lᵣ₋ᵢ by P_{Limit-i} generates fuel cost curve 302, which is a function of Ci and P_{Limit-i}, where i=1, 2, 3 . . . . N.

The charging revenue from EVSEs 208 for a given P_{Limit-i} may be estimated by the EV charging demand from the EV connection forecast calculation performed in block 304, minus the peak shaving determined by P_{Limit-i}. A digital twin of the peak shaving calculation is the virtual peak load shaving engine, calculated in block 308. The EV connection forecast calculation performed in block 304 may be implemented in a number of different ways, including but not limited to a machine learning based process. The output of the EV connection forecast model calculated in block 304 may include estimated EV arrival times, charging energy needs, max charging power, price tolerance, charging time tolerance, etc. Price tolerance and charging time tolerance may be considered as important parameters, and may be considered by the revenue with swept peak load shaving calculation performed in block 316. For the calculation in block 316, for a given Pₗᵢₘᵢₜ₋ᵢ, some of EVSEs 208 may have a higher charging rate tolerance EV connected and will be given a lower priority for charging. Therefore, besides an equal share and/or a first-in-first out (FIFO) load shaving mechanism, the virtual peak load shaving engine calculated in block 308 may also include control parameters to set an individual EVs charging priority.

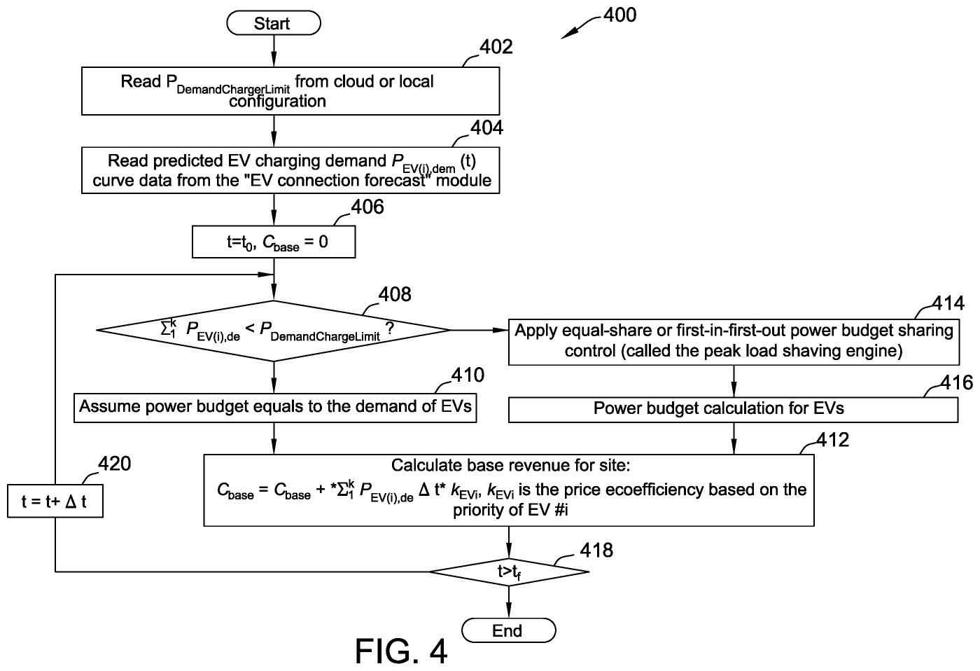

FIG. 4 depicts a flow chart of a method 400 of calculating a base revenue during a grid support event in an exemplary embodiment. Method 400 may be performed during the calculation at block 310 (see FIG. 3) while controller 202 and/or controller 102 operate in a grid support mode. t₀ and t_{f} are the start and end times for the calculation, respectively. C_{price} is the base price of energy charged to the customers, while Δt is a predetermined time step for the charger demand control.

In block 402, P_{DemandChargerLimit} is read from the cloud or from a local configuration at controller 102 and/or controller 202. P_{DemandChargerLimit} corresponds to the power level set forth in the bid sent to and accepted by ancillary service market 106, or simply a locally determined limit to avoid incurring utility imposed peak demand charges. During the grid support mode, controller 102 and/or controller 202 may operate to limit the power drawn by VPP 104 and/or VPP resource group 204 to P_{DemandChargerLimit}.

In block 404, the predicted EV charger demand P_{EV(i),dem} (t) curve data is obtained from the EV connection forecast calculation performed in block 304 (see FIG. 3). In block 406, the time step t is set to the initial time to, and the base revenue C_{base} is set to zero. In block 408, a determination is made whether Σ₁^{k}PEV (i), dem (where k is the number of EVs currently being charged) is less than P_{DemandChargeLimit}. If this is true (e.g., the power drawn by VPP 104 and/or VPP resource group 204 is less than the power limit set in the bid), then an assumption is made that the power budget equals the demand of the EVs, in block 410, and C_{base} is calculated in block 412 based on the assumption. If Σ₁^{k}PEV (i), dem is more than P_{DemandChargeLimit}, then the power drawn by VPP 104 and/or VPP resource group 204 is greater than the power limit set in the bid and the power should be reduced to what was previously submitted in the bid and accepted by ancillary service market 106. To do so, an equal-share or FIFO power budget sharing control is performed (e.g., via a peak load shaving engine), in block 414. In block 416, a power budget calculation for the EVs is performed, and in block 412, C_{base} is calculated, where C_{base}=Cprice*Σ₁^{k}PEV (i), dem Δt*K_{EVi}, where k_{EVi} is the price based on the priority of EV number i.

In block 418, a determination is made whether t>t_{f}. If this is true, then method 400 ends. Method 400 may also end if the grid support mode ends. If this is not true, then the time t is incremented by Δt, the predetermined time step, and processing returns to block 408.

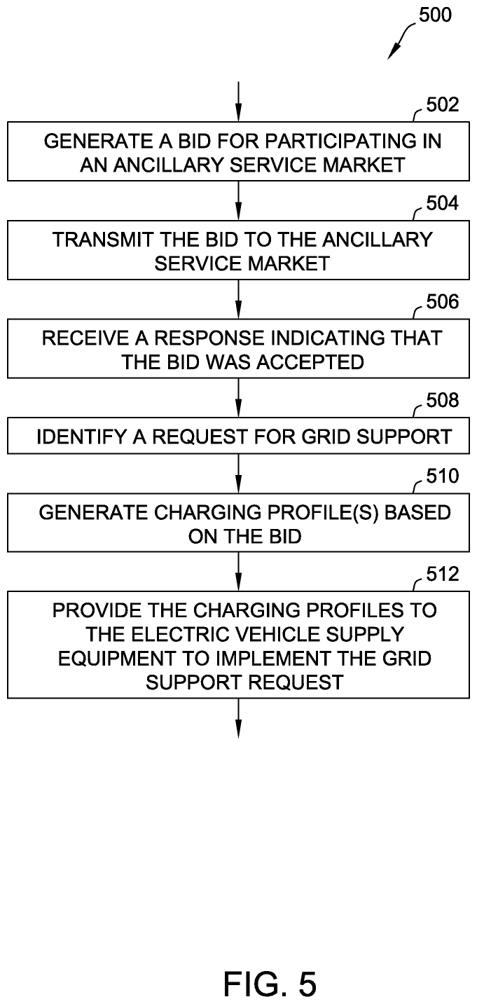

FIG. 5 depicts a flow chart of a method 500 of managing a participation of a VPP comprising a plurality of EVSEs in an ancillary service market for an electric grid in an exemplary embodiment. Method 500 will be discussed with respect to controller 102, although the discussion of method 500 applies equally to controller 202. Further, method 500 may be performed by other systems, not shown.

In this embodiment, method 500 comprises generating 502 a bid for participating in the ancillary service market over a time period, and transmitting 504 the bid to the ancillary service market. In one example, controller 102 generates and transmits bid 122 to ancillary service market 106. In another example, processor 114 generates bid 122 and transmits bid 122 to ancillary service market 106, using, for example, communication interfaces 116.

Method 500 further comprises receiving 506 a response from the ancillary service market indicating that the bid was accepted. In one example, controller 102 receives a response from ancillary service market 106 that bid 122 was accepted. In another example, processor 114 receives a response from ancillary service market 106 that bid 122 was accepted, using, for example, communication interfaces 116.

Method 500 further comprises identifying 508 a request from the ancillary service market for the VPP to provide grid support to the electric grid during the timer period, and generating 510, based on the bid and in response to the request, at least one charging profile for one or more of plurality of EVSEs of the VPP. In one example, controller 102 identifies the request from ancillary service market 106 for VPP 104 to provide grid support to electric grid 112 during the time period, and generates at least one charging profile 120 for one or more of the EVSEs 108 based on bid 122 and in response to the request. In another example, processor 114 identifies the request, using, for example, communication interfaces 116, from ancillary service market 106 for VPP 104 to provide grid support to electric grid 112 during the time period, and generates at least one charging profile 120 for one or more of the EVSEs 108 based on bid 122 and in response to the request.

Method 500 further comprises providing 512 the at least one charging profile to the one or more EVSEs to implement the request for the grid support. In one example, controller 102 provides one or more charging profiles 120 to EVSEs 108 to implement the request for the support of electric grid 112. In another example, processor 114 provides one or more charging profiles 120, using, for example, communication interfaces 116, to EVSEs 108 to implement the request for the support of electric grid 112.

In some embodiments of method 500, the request for grid support comprises an AGC request. For example, controller 102 may be requested to provide frequency support to electric grid 112. In some embodiments, method 500 further comprises generating a fuel cost curve for the VPP over the time period, and the bid is based on the fuel cost curve. For example, controller 102 may calculate the fuel cost curve as previously described with respect to FIG. 3, and bid 122 may be based on the fuel cost curve.

In some embodiments of method 500, the fuel cost curve is based on a compound revenue, where the compound revenue comprises a sum of charging revenue for the VPP at different power limits and revenue for participating in the ancillary service market at the different power limits. For example, controller 102 may calculate the compound revenue as previously described with respect to FIG. 3.

In some embodiments of method 500, the fuel cost curve is based on differences between the compound revenue and a base revenue, where the base revenue comprises the sum of the charging revenue for the VPP over the time period. For example, controller 102 may calculate the difference between the compound revenue and the base revenue, as previously described with respect to FIG. 3.

In some embodiments of method 500, the bid comprises a power level and a price for the VPP to participate in the ancillary service market, and one or more of charging profiles are generated based on the power level for the bid and a current power demand of the VPP on the electric grid. For example, controller 102 may generate bids 122 that include the power level and a price for VPP 104 to participate in ancillary service market 106, and one or more of charging profiles 120 may be generated based on the power level specified in bid 122 and a current power demand of VPP 104 on electric grid 112. For example, if the power level in the bid is eight hundred kilowatts and the current power drawn by VPP 104 on electric grid 112 is one megawatt, then controller 102 may modify one or more of charging profiles 120 sent to EVSEs 108 to reduce the power drawn by VPP to a power level at or below eight hundred kilowatts.

In some embodiments of method 500, generating one or more charging profiles is based on a priority associated with one or more of the EVSEs. For example, EV 110-1 may have a higher priority in charging than EV 110-N, and charging profile 120 for EVSE 108-1 may therefore be different than charging profile 120 for EVSE 108-N. The difference in priorities may be the result of any of the various factors previously described.

An example technical effect of the embodiments described herein includes at least one of: (a) facilitating the ability of EVSEs to participate in grid support using market incentives; (b) increasing the reliability of an electric grid that supports EVSEs; and (c) implementing fuel cost curves for EVSE based VPPs.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A controller for managing a participation of a virtual power plant comprising a plurality of electric vehicle supply equipment in an ancillary service market for an electric grid, the controller comprising:
at least one communication interface;
at least one processor configured to:
generate a bid for participating in the ancillary service market over a time period;
transmit, via the at least one communication interface, the bid to the ancillary service market;
receive, via the at least one communication interface, a response from the ancillary service market indicating that the bid was accepted;
identify a request from the ancillary service market for the virtual power plant to provide grid support to the electric grid during the time period;
generate, based on the bid and in response to the request, at least one charging profile for one or more of the plurality of electric vehicle supply equipment of the virtual power plant; and
provide, via the at least one communication interface, the at least one charging profile to the one or more of the plurality of electric vehicle supply equipment to implement the request for the grid support.

2. The controller of claim 1, wherein the request comprises an automatic generation control request.

3. The controller of claim 1, wherein:
the at least one processor is further configured to:
generate a fuel cost curve for the virtual power plant over the time period; and
generate the bid based on the fuel cost curve.

4. The controller of claim 3, wherein:
the at least one processor is further configured to generate the fuel cost curve based on a compound revenue, wherein the compound revenue comprises a sum of charging revenue for the virtual power plant at different power limits and a revenue for participating in the ancillary service market at the different power limits.

5. The controller of claim 4, wherein:
the at least one processor is further configured to generate the fuel cost curve based on a difference between the compound revenue and a base revenue, where in the base revenue comprises the sum of charging revenue for the virtual power plant over the time period.

6. The controller of claim 1, wherein:
the bid comprises a power level and a price for the virtual power plant to participate in the ancillary service market over the time period; and
the at least one processor is further configured to generate the at least one charging profile based on the power level for the bid and a current power demand of the virtual power plant on the electric grid.

7. The controller of claim 1, wherein:
the at least one processor is further configured to:
generate the at least one charging profile based on a priority associated with the one or more of the plurality of electric vehicle supply equipment.

8. A method of managing a participation of a virtual power plant comprising a plurality of electric vehicle supply equipment in an ancillary service market for an electric grid, the method comprising:
generating a bid for participating in the ancillary service market over a time period;
transmitting bid to the ancillary service market;
receiving a response from the ancillary service market indicating that the bid was accepted;
identifying a request from the ancillary service market for the virtual power plant to provide grid support to the electric grid during the time period;
generating, based on the bid and in response to the request, at least one charging profile for one or more of the plurality of electric vehicle supply equipment of the virtual power plant; and
providing the at least one charging profile to the one or more of the plurality of electric vehicle supply equipment to implement the request for the grid support.

9. The method of claim 8, wherein:
the request comprises an automatic generation control request.

10. The method of claim 8, wherein:
the method further comprises:
generating a fuel cost curve for the virtual power plant over the time period, and
generating the bid further comprises:
generating the bid based on the fuel cost curve.

11. The method of claim 10, wherein:
generating the fuel cost curve further comprises:
generating the fuel cost curve based on a compound revenue, wherein the compound revenue comprises a sum of charging revenue for the virtual power plant at different power limits and a revenue for participating in the ancillary service market at the different power limits.

12. The method of claim 11, wherein:
generating the fuel cost curve further comprises:
generating the fuel cost curve based on a difference between the compound revenue and a base revenue, where in the base revenue comprises the sum of charging revenue for the virtual power plant over the time period.

13. The method of claim 8, wherein:
the bid comprises a power level and a price for the virtual power plant to participate in the ancillary service market over the time period; and
generating the at least one charging profile further comprises:
generating the at least one charging profile based on the power level for the bid and a current power demand of the virtual power plant on the electric grid.

14. The method of claim 8, wherein:
generating the at least one charging profile further comprises:
generating the at least one charging profile based on a priority associated with the one or more of the plurality of electric vehicle supply equipment.

15. A controller for managing a plurality of electric vehicle supply equipment for participation in a frequency control of an electric grid, the controller comprising at least one processor configured to:
generate a bid to participate in the frequency control of the electric grid;
determine whether the bid was accepted;
identify a request to provide the frequency control of the electric grid; and
cause, based on the bid and in response to the request, one or more of the plurality of electric vehicle supply equipment to modify their electrical power drawn from the electric grid to implement the frequency control of the electric grid.

16. The controller of claim 15, wherein:
the at least one processor is further configured to:
generate a fuel cost curve for the one or more of the plurality of electric vehicle supply equipment over a time period; and
generate the bid based on the fuel cost curve.

17. The controller of claim 16, wherein:
the at least one processor is further configured to generate the fuel cost curve based on a compound revenue, wherein the compound revenue comprises a sum of charging revenue for the one or more of the plurality of electric vehicle supply equipment at different power limits and a revenue for participating in the frequency control at the different power limits.

18. The controller of claim 17, wherein:
the at least one processor is further configured to generate the fuel cost curve based on a difference between the compound revenue and a base revenue, where in the base revenue comprises the sum of charging revenue for the one or more of the plurality of electric vehicle supply equipment over the time period.

19. The controller of claim 15, wherein:
the bid comprises a power level and a price for the one or more of the plurality of electric vehicle supply equipment to participate in the frequency control; and
the at least one processor is further configured to cause the one or more of the plurality of electric vehicle supply equipment to modify their electrical power drawn from the electric grid based on the power level for the bid and a current power demand of the one or more of the plurality of electric vehicle supply equipment on the electric grid.

20. The controller of claim 15, wherein:
the at least one processor is further configured to:
cause the one or more of the plurality of electric vehicle supply equipment to vary a charging profile for one or more electric vehicles coupled thereto in order to modify their electrical power drawn from the electric grid.
